(19) United States
(12) Patent Application Publication
(10) Pub. No.: US 2014/0380244 A1
(43) Pub. Date: Dec. 25, 2014

(54) VISUAL TABLE OF CONTENTS FOR TOUCH SENSITIVE DEVICES

(71) Applicant: barnesandnoble.com llc, New York, NY (US)

(72) Inventors: Jaireh Tecarro, San Francisco, CA (US); Chen-Je Huang, Menlo Park, CA (US); Yu- Wei Hsu, Burlingame, CA (US); Matthew Pallakoff, Mountain View, CA (US)

(21) Appl. No.: 13/923,709

(22) Filed: Jun. 21, 2013

(51) Int. Cl. G06F 3/0482

(52) U.S. Cl. CPC G06F 3/0482
USPC 715/838

(57) ABSTRACT

Techniques are disclosed for engaging and displaying a visual table of contents in electronic touch sensitive devices. The user can engage the visual table of contents by, for example, performing an activation gesture, such as an inward two-contact pinch gesture. The visual table of contents may display the paginated content to the user as a grid of image tiles, each image corresponding to a page or spread of pages. Each page of content may be accompanied by its appropriate page number. The visual table of contents may display the paginated content as page spreads, wherein each page is paired with its opposite facing page. The user may scroll through the visual table of contents if the device screen is not large enough to display all of the pages on a single screen. Selecting a page from the table of contents may display the selected page to the user.

### FIELD OF THE DISCLOSURE

This disclosure relates to electronic display devices, and more particularly, to user interface (UI) techniques for interacting with touch screen devices.

### BACKGROUND

Electronic display devices such as tablets, eReaders, mobile phones, smart phones, personal digital assistants (PDAs), and other such touch screen electronic display devices are commonly used for displaying consumable content. The content may be, for example, an eBook, an online article or blog, images, a movie or video, a map, just to name a few types. Such display devices are also useful for displaying a user interface that allows a user to interact with an application running on the device. The user interface may include, for example, one or more touch screen controls and/or one or more displayed labels that correspond to nearby hardware buttons. The touch screen display may be backlit or not, and may be implemented for instance with an LED screen or an electrophoretic display. Such devices may also include other touch sensitive surfaces, such as a track pad (e.g., capacitive or resistive touch sensor) or touch sensitive housing (e.g., acoustic sensor).

### BRIEF DESCRIPTION OF THE DRAWINGS

FIGS. 1a-b illustrate an example electronic touch screen device having a visual table of contents mode configured in accordance with an embodiment of the present invention.

FIGS. 1c-d illustrate example configuration screen shots of the user interface of the electronic touch screen device shown in FIGS. 1a-b, configured in accordance with an embodiment of the present invention.

FIG. 2a illustrates a block diagram of an electronic touch screen device configured in accordance with an embodiment of the present invention.

FIG. 2b illustrates a block diagram of a communication system including the electronic touch screen device of FIG. 2a, configured in accordance with an embodiment of the present invention.

FIGS. 3a-b illustrate an example visual table of contents mode of an electronic touch screen device, in accordance with an embodiment of the present invention.

FIGS. 4a-d illustrate an example visual table of contents mode of an electronic touch screen device, in accordance with another embodiment of the present invention.

FIGS. 5a-b illustrate an example visual table of contents mode of an electronic touch screen device, in accordance with another embodiment of the present invention.

FIGS. 6a-c illustrate an example visual table of contents mode of an electronic touch screen device, in accordance with another embodiment of the present invention.

FIG. 7 illustrates a method for providing a visual table of contents mode in an electronic touch screen device, in accordance with an embodiment of the present invention.

### DETAILED DESCRIPTION

Techniques are disclosed for engaging and displaying a visual table of contents in electronic touch sensitive devices. The user can engage the visual table of contents by performing an activation gesture, such as an inward two-contact pinch gesture in one embodiment. Once the visual table of contents mode is engaged, the paginated content may be displayed to the user as a grid of image tiles, each image corresponding to a single page and accompanied by the appropriate page number. In some such embodiments, the table of contents image tiles may be grouped by page spreads, wherein each page is paired with its opposite facing page, mimicking the experience of opening and viewing two pages of a physical book or magazine. Each page spread may include a center crease or virtual binding and the pages may be slightly shaded near the crease of the page spread. The paginated content may include too many pages to be displayed at one time on the device screen, and in such cases the user interface and/or control features may scroll through the visual table of contents using any suitable scrolling command. Selecting any page from the visual table of contents may exit the visual table of contents mode and display the selected page to the user. The user may subsequently return to the visual table of contents mode by performing the activation gesture. The user may also engage the visual table of contents mode using a UI control feature, such as by tapping a grid icon.

General Overview

As previously explained, electronic display devices such as tablets, eReaders, and smart phones are commonly used for displaying user interfaces and consumable content. In some instances, the user might desire to preview or navigate through paginated digital content. For instance, the user might wish to search through a table of contents to preview a magazine or find a desired section of a book or article. While some electronic devices provide a textual outline or table of contents, there does not appear to be a user interface visual table of contents function that can be efficiently and intuitively implemented with touch-screen gestures by the user.

Thus, and in accordance with an embodiment of the present invention, techniques are provided for displaying and navigating a visual table of contents in electronic touch sensitive devices. The visual table of contents mode can be used, for example, to display the pages of a digital file as a grid of thumbnail images, each image associated with a page of the digital file. In such an example, the user may navigate through any paginated digital content while viewing smaller samples of the content on each page. In some cases, when the user wishes to return to a document reading mode, selecting the thumbnail image associated with a specific page will display that page and allow the user to continue reading. In one embodiment, the thumbnail images are grouped together in page spreads, similar to the way physical pages appear when a magazine or book is opened. In such an example, the front and back cover of an eBook, magazine, or other paginated content may be displayed individually while each inner page is paired together with its opposite facing page. Thus, the visual table of contents may be shown as a grid of page spreads, each page spread including two thumbnail images with a center virtual binding between them. In some cases the thumbnails may be shaded, or slightly darkened near the virtual binding, mimicking the shadows that appear at the centerfold of a physical magazine or book and providing a more realistic user experience.

The user can engage the visual table of contents mode with a particular activation gesture, such as an inward pinch gesture with two or more fingers or by selecting a visual table of contents UI control feature on the touch screen device. The UI control feature may be included in an options menu within an eReader application. In a more general sense, any uniquely identifiable touch of a touch sensitive surface by the user can be used to engage the visual table of contents mode. The gestures can be performed, for example, with the tip of a finger or a stylus, or any other suitable implement capable of providing a detectable touch screen gesture. The uniqueness of the touch may be based, for example, on the particular location of the touch and/or the nature of the touch (e.g., expanding two contact points, expanding two contact points with another button pressed, etc.). Once engaged, the visual table of contents mode assists the user in viewing and navigating the paginated content.

In some embodiments, the pinch gesture may be associated with the visual table of contents mode as well as a zoom-in/out function, and both functions may be coordinated in a number of ways. In some example embodiments, the zoom function may be associated with a simple pinch gesture while the visual table of contents mode is associated with a pinch gesture when a certain control feature or button is held, or vice versa. Alternatively, the zoom function may be associated with a two touch point pinch gesture while the visual table of contents mode is associated with a three touch point pinch gesture, or vice versa. In other embodiments, the inward pinch gesture may zoom-out on the content currently displayed on the screen until that content reaches a lower size limit or boundary. In such an example, when the content is zoomed-out to the upper boundary size (e.g., viewing an entire page on the screen.), subsequent inward pinch gestures may be configured to engage the visual table of contents mode.

In some embodiments, the user may abandon the visual table of contents mode by, for example, tapping an area of the screen away from any page thumbnail, thus returning the user to the original page displayed before the visual table of contents mode was activated. The abandon of the visual table of contents mode may also be implemented with a back arrow button, in some embodiments. Any number of applications or device functions may benefit from a visual table of contents mode as provided herein, whether user-configurable or not, and the claimed invention is not intended to be limited to any particular application or set of applications. Example applications may include an eBook application, a video player application, a browser application, a file manager application, a word processor application, a document viewer application, just to name a few examples. Given the global nature and/or uniqueness of the engagement mechanism, in accordance with some embodiments, the visual table of contents mode can be similarly invoked within multiple diverse applications (e.g., eBook, document viewer, picture viewer, file manager, etc.) and without conflicting with other global gestures that might also be used by the device's operating system.

Numerous uniquely identifiable engagement schemes that exploit a touch sensitive surface can be used as will be appreciated in light of this disclosure. Further note that any touch sensitive device (e.g., track pad, touch screen, or other touch sensitive surface, whether capacitive, resistive, acoustic or other touch detecting technology) may be used to detect the user contact and the claimed invention is not intended to be limited to any particular type of touch sensitive technology, unless expressly stated.

Architecture

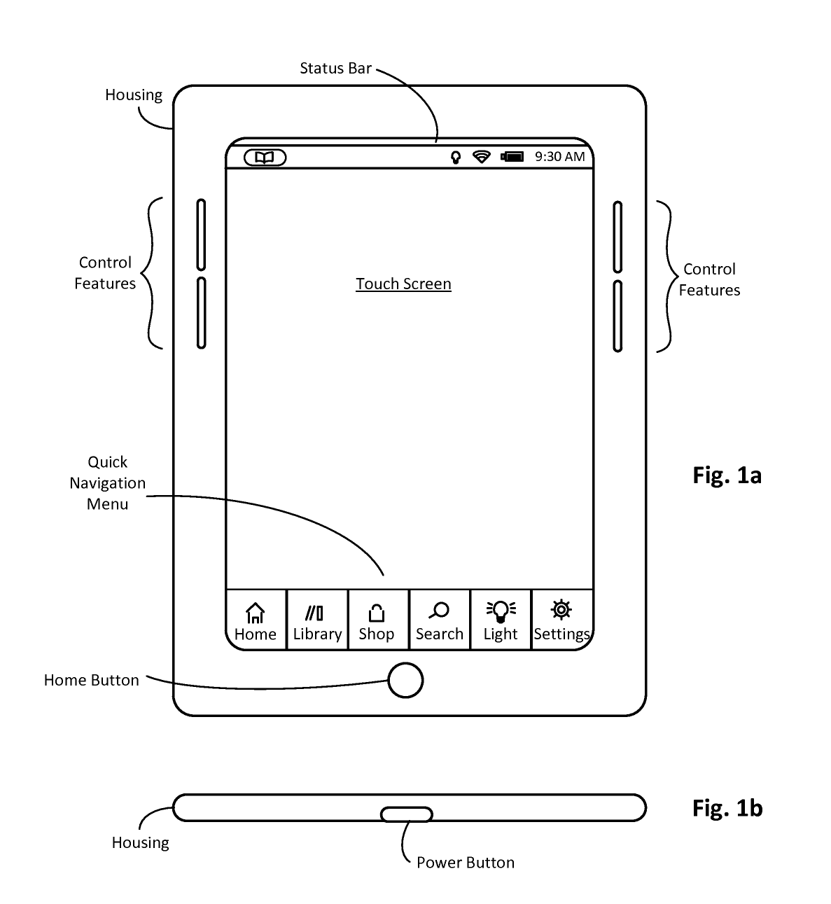

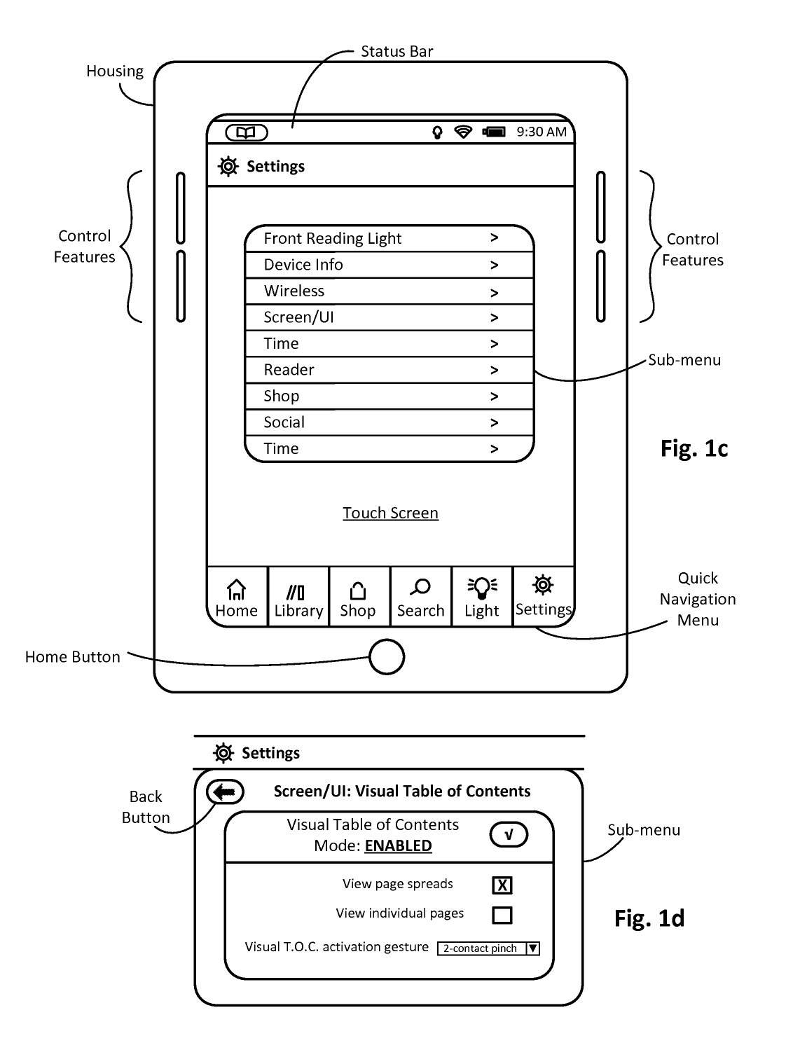

FIGS. 1a-b illustrate an example electronic touch sensitive device having a visual table of contents mode configured in accordance with an embodiment of the present invention. As can be seen, in this example embodiment, the touch sensitive surface is a touch screen display. The device could be, for example, a tablet such as the NOOK® tablet or eReader by Barnes & Noble. In a more general sense, the device may be any electronic device having a touch sensitive user interface for detecting direct touch or otherwise sufficiently proximate contact, and capability for displaying content to a user, such as a mobile phone or mobile computing device such as a laptop, a desktop computing system, a television, a smart display screen, or any other device having a touch sensitive display or a non-sensitive display screen that can be used in conjunction with a touch sensitive surface. As will be appreciated, the claimed invention is not intended to be limited to any specific kind or type of electronic device.

As can be seen with this example configuration, the device comprises a housing that includes a number of hardware features such as a power button, control features, and a press-button (sometimes called a home button herein). A user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI features, or different UI features altogether, depending on the target application of the device. Any such general UI controls and features can be implemented using any suitable conventional or custom technology, as will be appreciated.

The hardware control features provided on the device housing in this example embodiment are configured as elongated press-bars and can be used, for example, to page forward (using the top press-bar) or to page backward (using the bottom press-bar), such as might be useful in an eReader application. The power button can be used to turn the device on and off, and may be used in conjunction with a touch-based UI control feature that allows the user to confirm a given power transition action request (e.g., such as a slide bar or tap point graphic to turn power off). Numerous variations will be apparent, and the claimed invention is not intended to be limited to any particular set of hardware buttons or UI features, or device form factor.

In one example configuration, the home button is a physical press-button that can be used as follows: when the device is awake and in use, pressing the button will display the quick navigation menu, which is a toolbar that provides quick access to various features of the device. The home button may also be configured to cease an active function that is currently executing on the device (such as the visual table of contents mode), or close a configuration sub-menu that is currently open. The button may further control other functionality if, for example, the user presses and holds the home button. For instance, an example such push-and-hold function could engage a power conservation routine where the device is put to sleep or an otherwise lower power consumption mode. So, a user could grab the device by the button, press and keep holding as the device is stowed into a bag or purse. Thus, one physical gesture may safely put the device to sleep. In such an example embodiment, the home button may be associated with and control different and unrelated actions: 1) show the quick navigation menu; 2) exit a configuration sub-menu; and 3) put the device to sleep. As can be further seen, the status bar may also include a book icon (upper left corner). In some cases, selecting the book icon may provide bibliographic information on the content or provide the main menu or table of contents for the book, movie, playlist, or other content.

In one particular embodiment, a visual table of contents mode configuration sub-menu, such as the one shown in FIG. 1d, may be accessed by selecting the Settings option in the quick navigation menu, which causes the device to display the general sub-menu shown in FIG. 1c. From this general sub-menu, the user can select any one of a number of options, including one designated Screen/UI in this specific example case. Selecting this sub-menu item may cause the configuration sub-menu of FIG. 1d to be displayed, in accordance with an embodiment. In other example embodiments, selecting the Screen/UI option may present the user with a number of additional sub-options, one of which may include a so-called “visual table of contents mode” option, which may then be selected by the user so as to cause the configuration sub-menu of FIG. 1d to be displayed. Any number of such menu schemes and nested hierarchies can be used, as will be appreciated in light of this disclosure. In other embodiments, the visual table of contents function is hard-coded such that no configuration sub-menus are needed or otherwise provided (e.g., performing a pinch gesture to view a visual table of contents as described herein, with no user configuration needed). The degree of hard-coding versus user-configurability can vary from one embodiment to the next, and the claimed invention is not intended to be limited to any particular configuration scheme of any kind, as will be appreciated.

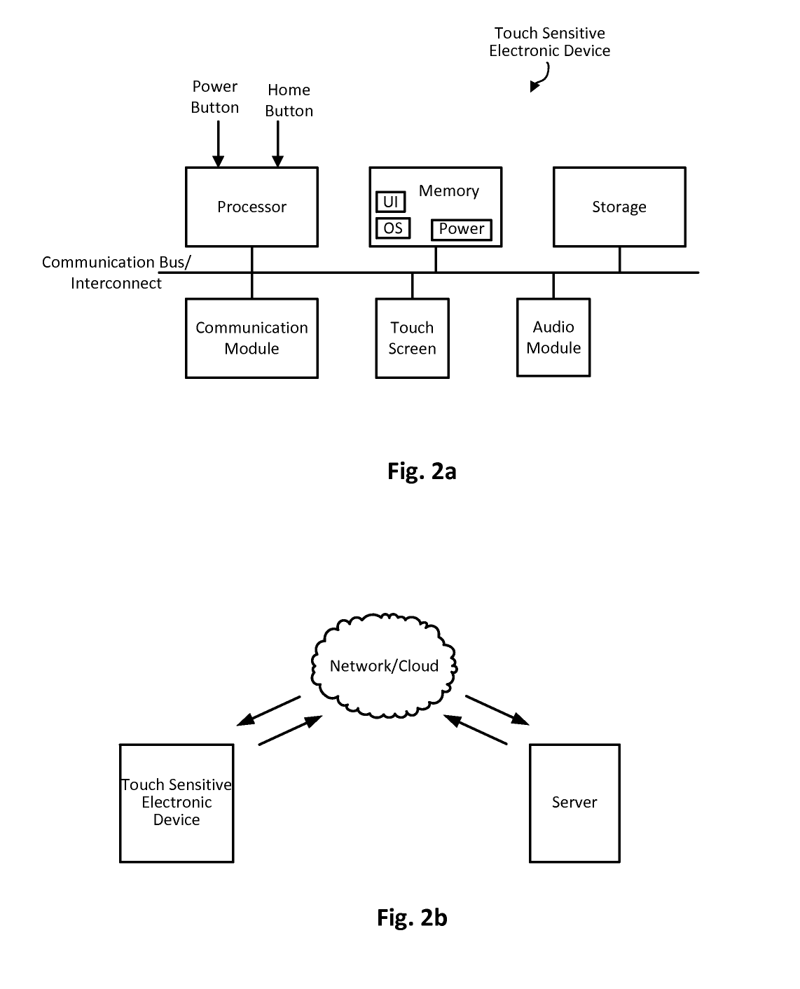

As will be appreciated, the various UI control features and sub-menus displayed to the user are implemented as touch screen controls in this example embodiment. Such UI screen controls can be programmed or otherwise configured using any number of conventional or custom technologies. In general, the touch screen display translates a touch (direct or hovering, by a user's hand, a stylus, or any other suitable implement) in a given location into an electrical signal which is then received and processed by the device's underlying operating system (OS) and circuitry (processor, etc.). In some instances, note that the user need not actually physically touch the touch sensitive device to perform an action. For example, the touch screen display may be configured to detect input based on a finger or stylus hovering over the touch sensitive surface (e.g., within 3 inches of the touch screen). Additional example details of the underlying OS and circuitry in accordance with some embodiments will be discussed in turn with reference to FIG. 2a.

The touch sensitive surface (or touch sensitive display, in this example case) can be any surface that is configured with touch detecting technologies, whether capacitive, resistive, acoustic, active-stylus, and/or other input detecting technology, including direct contact and/or proximate contact. In some embodiments, the screen display can be layered above input sensors, such as a capacitive sensor grid for passive touch-based input, such as with a finger or passive stylus contact in the case of a so-called in-plane switching (IPS) panel, or an electro-magnetic resonance (EMR) sensor grid for sensing a resonant circuit of a stylus. In some embodiments, the touch sensitive display can be configured with a purely capacitive sensor, while in other embodiments the touch screen display may be configured to provide a hybrid mode that allows for both capacitive input and EMR input, for example. In still other embodiments, the touch sensitive surface is configured with only an active stylus sensor. Numerous touch screen display configurations can be implemented using any number of known or proprietary screen based input detecting technologies. In any such embodiments, a touch sensitive controller may be configured to selectively scan the touch sensitive surface and/or selectively report user inputs detected directly on or otherwise sufficiently proximate to (e.g., within a few centimeters, or otherwise sufficiently close so as to allow detection) the detection surface (or touch sensitive display, in this example case).

As previously explained, and with further reference to FIGS. 1c and 1d, once the Settings sub-menu is displayed (FIG. 1c), the user can then select the Screen/UI option. In response to such a selection, the visual table of contents mode configuration sub-menu shown in FIG. 1d can be provided to the user. The user can configure a number of functions with respect to the visual table of contents mode, in this example embodiment. For instance, in this example case, the configuration sub-menu includes a UI check box that when checked or otherwise selected by the user, effectively enables the visual table of contents mode (shown in the enabled state); unchecking the box disables the mode. Other embodiments may have the visual table of contents mode always enabled, or enabled by a physical switch or button located on the device, for example. As previously explained, the visual table of contents mode may be configured to display the paginated content as page spreads, or as individual pages. In this particular example, the user has chosen to view the table of contents in a page spread format by selecting the appropriate UI check box. In some embodiments, the user may also configure the visual table of contents activation gesture. The various gestures that may be associated with the visual table of contents mode may be displayed to the user in a drop-down menu or any other suitable selection format. In this particular example, the user has selected the two-contact pinch gesture from a drop-down menu, thus configuring that gesture as the visual table of contents activation gesture.

As can be further seen, a back button arrow UI control feature may be provisioned on the screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. The configuration sub-menu shown in FIG. 1d is presented merely as an example of how a visual table of contents mode may be configured by the user, and numerous other configurable or hardcodable aspects will be apparent in light of this disclosure. Note that in some embodiments the visual table of contents mode may be visually and/or aurally demonstrated or otherwise confirmed to the user via animations or sound effects. Such animations and sound effects may provide clarity to the function being performed or otherwise enhance the user experience. In some embodiments, the animations and/or sound effects may be user-configurable, while in other embodiments they are hard-coded.

FIG. 2a illustrates a block diagram of an electronic touch screen device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). The touch screen and underlying circuitry is capable of translating a user's contact (direct or proximate) with the screen into an electronic signal that can be manipulated or otherwise used to trigger a specific user interface action, such as those provided herein. The principles provided herein equally apply to any such touch sensitive devices. For ease of description, examples are provided with touch screen technology.

In this example embodiment, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a UI having a visual table of contents mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., Texas Instruments OMAP4, dual-core ARM Cortex-A9, 1.5 GHz), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 6-inch E-ink Pearl 800×600 pixel screen with a 7 to 9 inch 1920×1280 IPS LCD touchscreen touch screen, or any other suitable display and touchscreen interface technology. The communications module can be, for instance, any suitable 802.11 b/g/n WLAN chip or chip set, which allows for connection to a local network, and so that content can be exchanged between the device and a remote system (e.g., content provider or repository depending on the application of the device). In some specific example embodiments, the device housing that contains all the various componentry measures about 7″ to 9″ high by about 5″ to 6″ wide by about 0.5″ thick, and weighs about 7 to 8 ounces. Any number of suitable form factors can be used, depending on the target application (e.g., laptop, desktop, mobile phone, etc.). The device may be smaller, for example, for smartphone and tablet applications and larger for smart computer monitor and laptop applications.

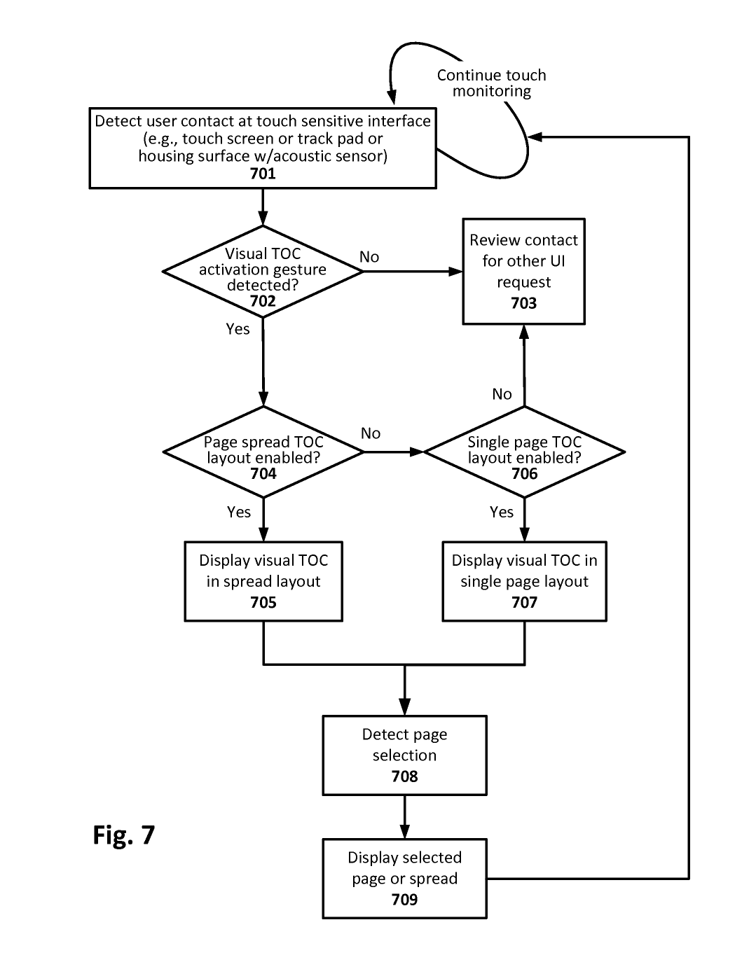

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module can be, for example, based on touchscreen technology and the various example screen shots and use-case scenarios shown in FIGS. 1a, 1c-d, 3a-b, 4a-d, 5a-b, and 6a-c, and in conjunction with the visual table of contents methodologies demonstrated in FIG. 7, which will be discussed in turn. The audio module can be configured to speak or otherwise aurally present, for example, a table of contents, a selected eBook, or other textual content, if preferred by the user. Numerous commercially available text-to-speech modules can be used, such as Verbose text-to-speech software by NCH Software. In some example cases, if additional space is desired, for example, to store digital books or other content and media, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

Client-Server System

FIG. 2b illustrates a block diagram of a communication system configured in accordance with an embodiment of the present invention. As can be seen, the system generally includes an electronic touch sensitive device (such as the one in FIG. 2a) that is capable of communicating with a server via a network/cloud. In this example embodiment, the electronic touch sensitive device may be, for example, an eBook reader, a mobile cell phone, a laptop, a tablet, desktop, or any other touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by performing a desired function or providing the user with requested or otherwise recommended content. In some such embodiments, the server is configured to remotely provision a visual table of contents mode as provided herein to the touch screen device (e.g., via JavaScript or other browser based technology). In other embodiments, portions of the visual table of contents methodology are executed on the server and other portions of the methodology are executed on the device. Numerous server-side/client-side execution schemes can be implemented to facilitate a visual table of contents mode in accordance with an embodiment, as will be apparent in light of this disclosure.

Visual Table of Contents Mode Examples

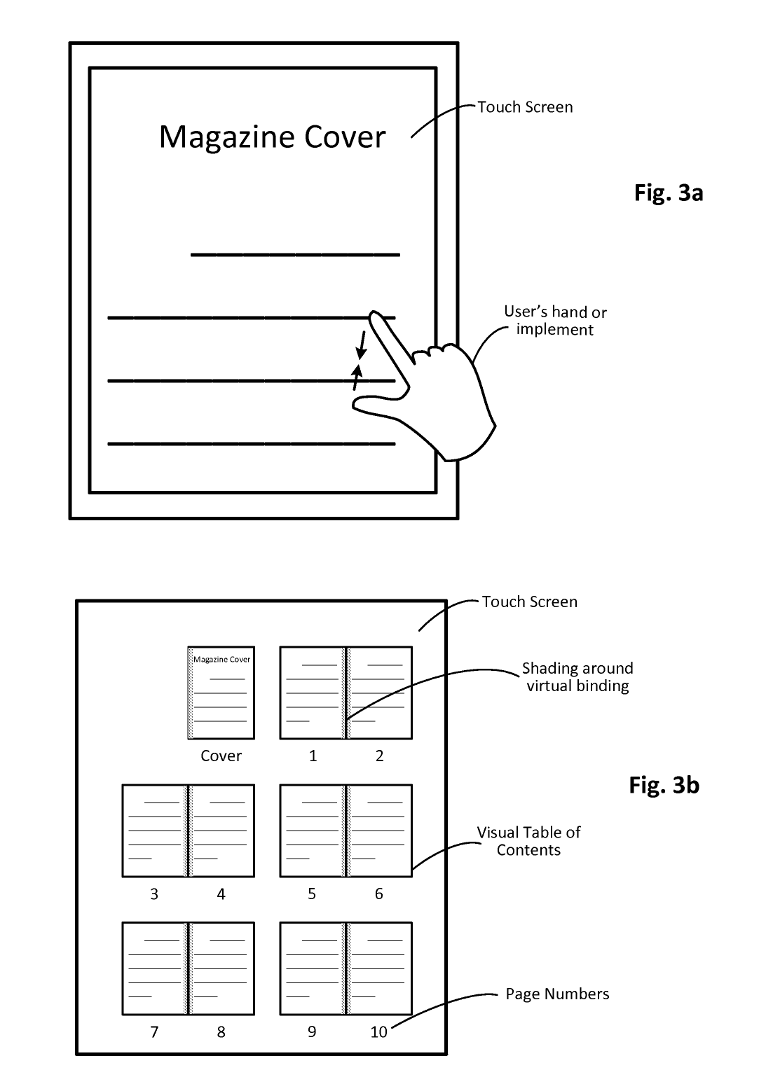

FIGS. 3a-b collectively illustrate an example visual table of contents mode that can be applied to a touch sensitive display of an electronic device, in accordance with an embodiment of the present invention. As can be seen, the touch screen of the device is displaying the cover of a magazine, and the user can interact with the touch screen with a hand or other suitable implement. In the particular example shown in FIG. 3a, the content displayed on the screen is zoomed to 100%, the visual table of contents mode activation gesture is configured to be a two-contact pinch gesture, and the user is performing a two-contact inward pinch gesture on the touch screen. As can be seen in FIG. 3b, when the inward pinch gesture is performed, the visual table of contents mode is engaged and the magazine cover and pages are displayed on the touch screen. In this particular example, the visual table of contents shows the magazine cover by itself, and each inner page is shown paired with its opposite facing page. Because the magazine cover does not have an opposite page to be paired with, it is shown with an empty space next to it in this particular example. In one example embodiment, a crease or virtual binding between each page spread may be shown with the pages slightly shaded near the crease, mimicking the experience of opening and viewing a physical magazine with two pages spread open.

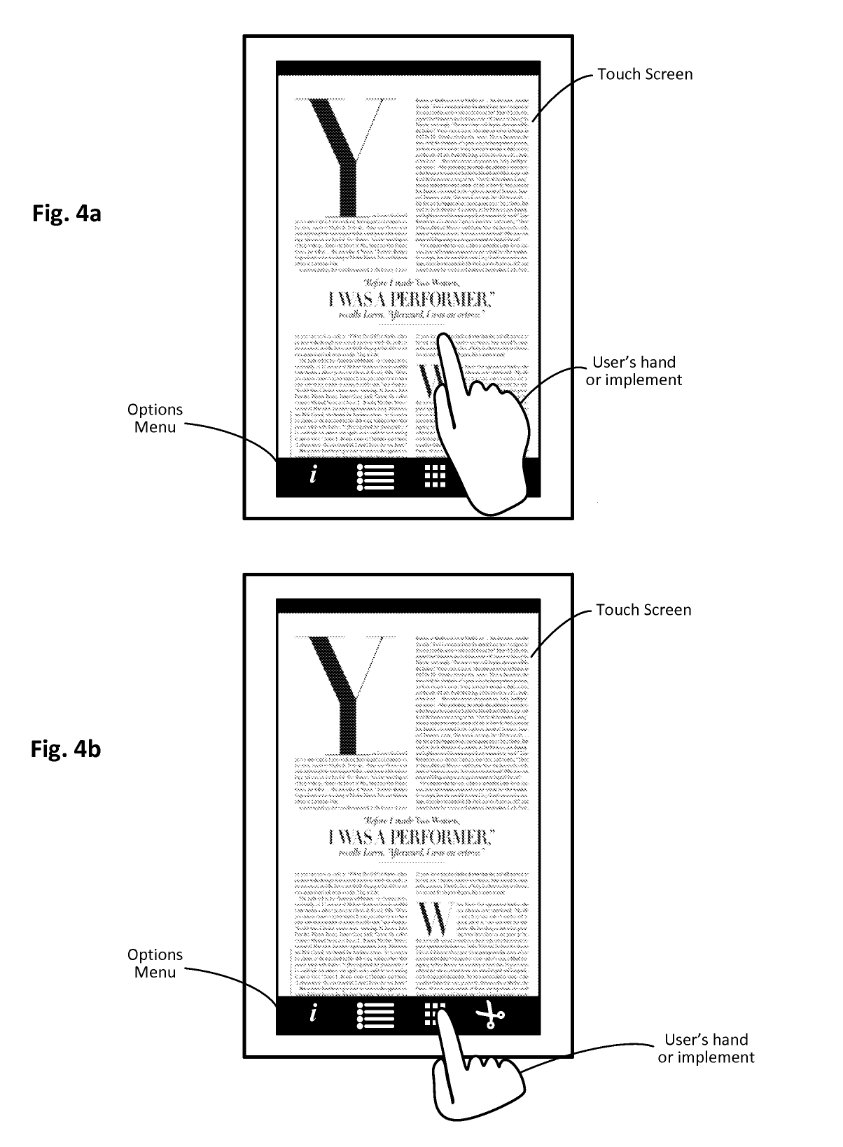

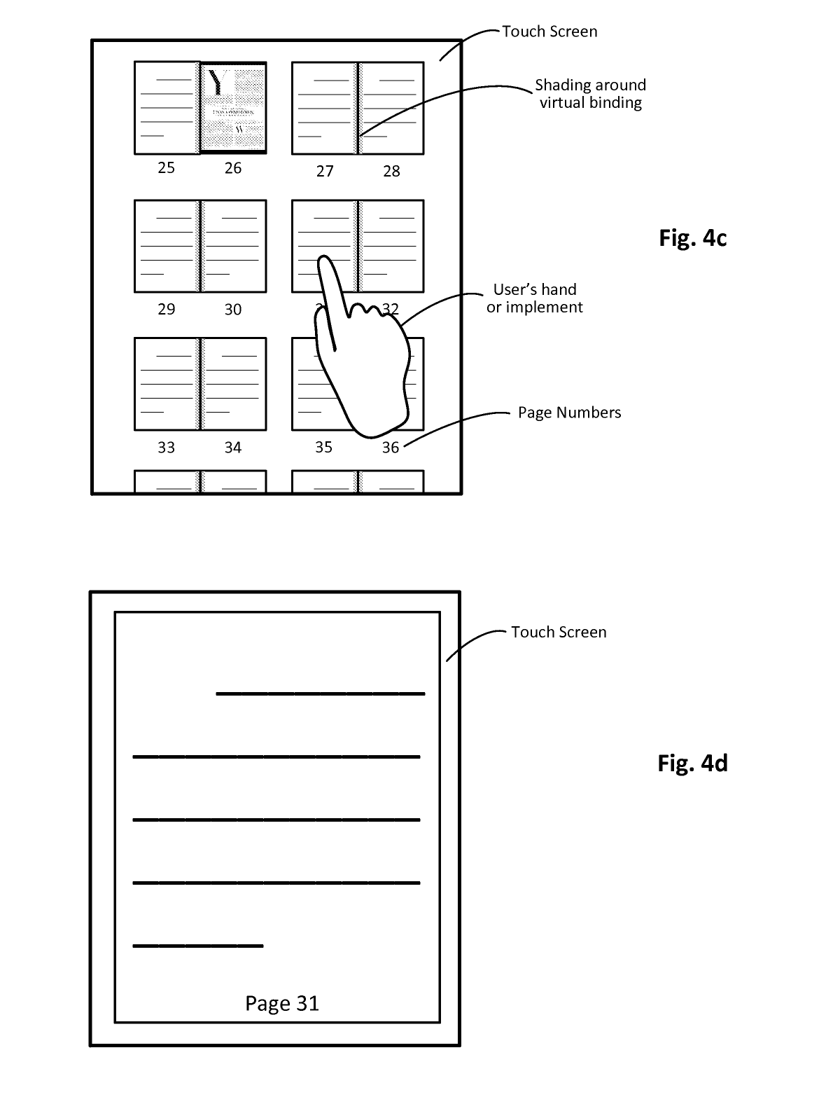

FIGS. 4a-d collectively illustrate an example visual table of contents mode that can be applied to a touch sensitive display of an electronic device, in accordance with another embodiment of the present invention. As can be seen, the touch screen of the device is displaying a page of digital content, and the user can interact with the touch screen with a hand or other suitable implement. In this example embodiment, an options menu may be provided to the user in response to a screen tap on a piece of content. As can be seen with reference to FIG. 4a, the options menu may contain a number of icons, including an “i” which may display information regarding the content displayed on the device, a table of contents icon, and a visual table of contents icon shown as a grid of tiles, among other function icons. The user may engage the visual table of contents mode by selecting the visual table of contents icon, as shown in FIG. 4b. In response to selecting the visual table of contents icon, the device may display the visual table of contents shown in FIG. 4c, including appropriate page numbers associated with each page In this particular example, the user was viewing page 26 when the visual table of contents command was performed, and therefore the page spread including pages 25-26 is included in the sample of page spreads currently shown. In some embodiments, the digital content may include more pages than can be shown on one screen and the user may scroll up or down to view previous or subsequent page spreads using finger swipes or some other suitable scrolling command, or UI control features such as scroll bars. In the example shown in FIG. 4c, the user wishes to view page 31 and has selected the visual table of contents image associated with that page, thus displaying the page as shown in FIG. 4d.

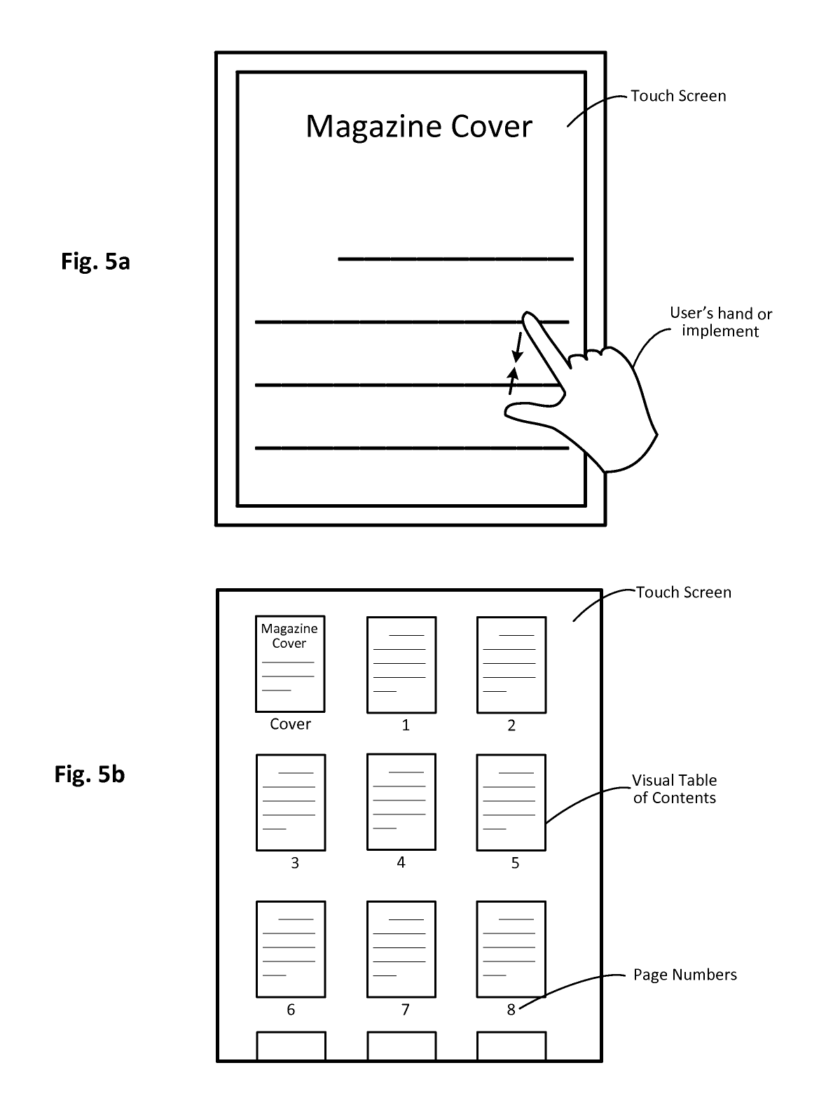

FIGS. 5a-b collectively illustrate an example visual table of contents mode that can be applied to a touch sensitive display of an electronic device, in accordance with another embodiment of the present invention. As can be seen, the touch screen of the device is displaying the cover of a magazine, and the user can interact with the touch screen with a hand or other suitable implement. In the particular example shown in FIG. 5a, the content displayed on the screen is zoomed to 100%, the visual table of contents mode activation gesture is configured to be a two-contact pinch gesture, and the user is performing a two-contact inward pinch gesture on the touch screen. Although the previous examples displayed the visual table of contents as page spreads having each page paired with its opposite facing page, the visual table of contents may also display an array of individual page images. Such an example is illustrated in FIG. 5b wherein each page is displayed individually each associated with its appropriate page number, in accordance with an embodiment.

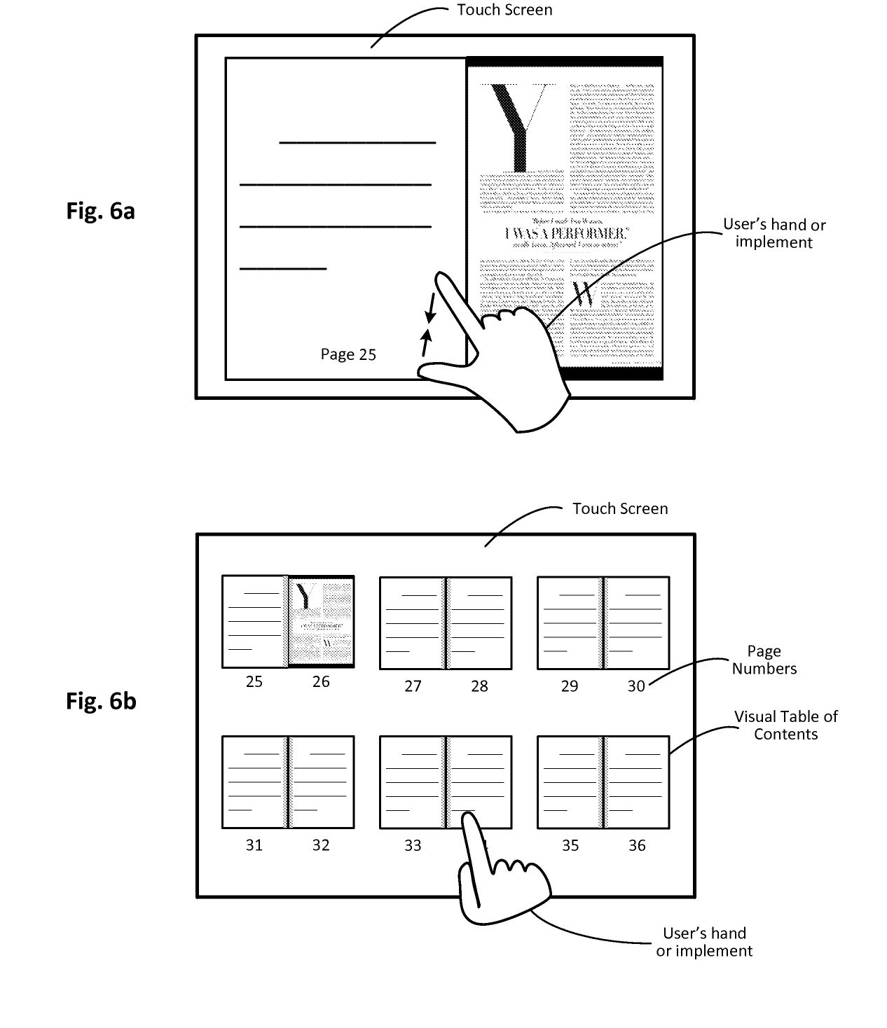

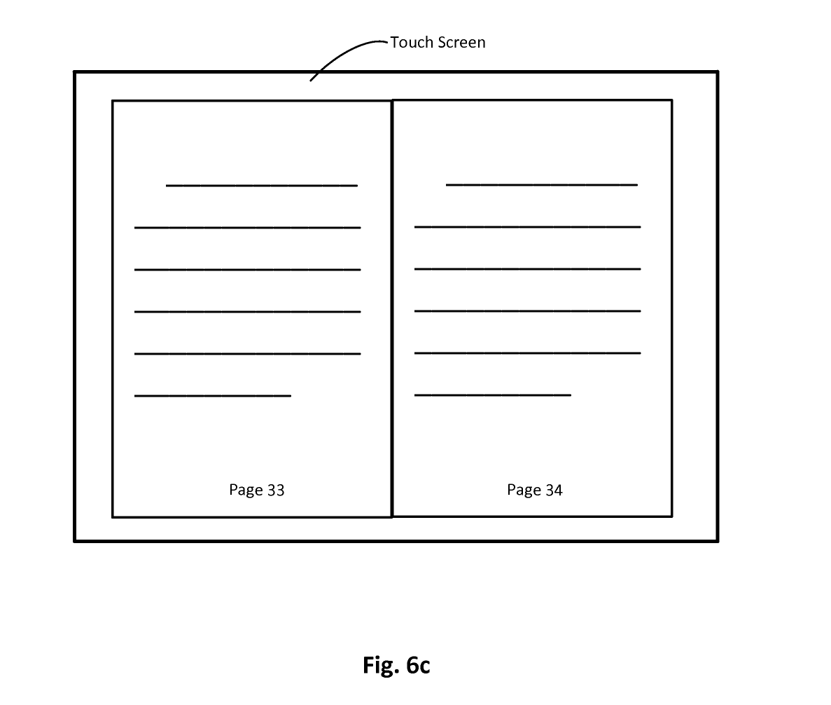

FIGS. 6a-c collectively illustrate an example visual table of contents mode that can be applied to a touch sensitive display of an electronic device, in accordance with another embodiment of the present invention. As can be seen, the device is being held in the landscape position, the touch screen of the device is displaying two pages of digital content, and the user can interact with the touch screen with a hand or other suitable implement. In the particular example shown in FIG. 6a, the content displayed on the screen is zoomed to 100%, the visual table of contents mode activation gesture is configured to be a two-contact inward pinch gesture, and the user is performing that gesture on the touch screen. As can be seen in FIG. 6b, when the inward pinch gesture is performed, the visual table of contents mode is engaged and the page spread images are displayed on the touch screen with their corresponding page numbers. In this specific embodiment, while the device is being held in the landscape position, selecting any one of the page spreads of the visual table of contents will display both of those pages, as shown in FIG. 6c.

Methodology

FIG. 7 illustrates a method for providing a visual table of contents mode in an electronic touch screen device, in accordance with an embodiment of the present invention. This example methodology may be implemented, for instance, by the UI module of the example touch screen device shown in FIG. 2a, or the example touch screen device shown in FIG. 2b (e.g., with the UI provisioned to the client by the server). To this end, the UI can be implemented in software, hardware, firmware, or any combination thereof, as will be appreciated in light of this disclosure.

As can be seen, the method generally includes sensing a user's input by a touch screen display. As soon as the user begins to swipe, drag or otherwise move a contact point, the UI code (and/or hardware) can assume a swipe gesture has been engaged and track the path of the contact point with respect to any fixed point within the touch screen until the user stops engaging the touch screen surface. The release point can also be captured by the UI as it may be used to commit the action started when the user pressed on the touch sensitive screen. In some cases, however, the gesture used for the visual table of contents does not require a release and may involve detecting two swipe gestures traveling for a certain distance forming a pinch gesture. In a similar fashion, if the user releases hold without moving the contact point, a tap or press or press-and-hold command may be assumed depending on the amount of time the user was continually pressing on the touch sensitive screen. These main detections can be used in various ways to implement UI functionality, including a visual table of contents mode as variously described herein, as will be appreciated in light of this disclosure.

In this example case, the method includes detecting 701a user contact at a touch sensitive interface. The touch sensitive interface may include a touch screen, track pad, touch sensitive housing with an acoustic sensor, or any other touch sensitive surface. In some embodiments, the contact monitoring is effectively continuous. When a user contact is detected, the method may continue with determining 702 whether a visual table of contents activation gesture is detected. This gesture may be user-configurable or hard-coded. If no visual table of contents activation gesture is detected, the user contact may be reviewed 703 for some other UI request. If the visual table of contents activation gesture is detected, the method may continue with determining 704 whether the page spread table of contents layout is enabled. If the page spread table of contents layout is enabled, the method may continue with displaying 705 the visual table of contents in the page spread layout, wherein each page is paired with its opposite facing page. If, however, the page spread table of contents layout is not enabled, the method may continue with determining 706 whether the single page table of contents layout is enabled. If this layout is not enabled, the user contact may be reviewed 703 for some other UI request. If the single page visual table of contents layout is enabled, the method may continue with displaying 707 the visual table of contents in the single page layout. The method may continue with detecting 708 a page selection from the visual table of contents screen. Such a page selection may be performed using the user's hand, a stylus, or any other suitable selection method, and may include selecting one of the page thumbnails or a page spread shown in the visual table of contents. Once the page selection is detected, the method may continue with displaying 709 the selected page or spread of pages. In some embodiments, if the device is held in the landscape position the selected page spread may be displayed, while only a single page may be displayed when the device is held in the portrait position. In some embodiments, the visual table of contents may draw the content pages from the cloud. In one such embodiment, the user's device must download the whole eBook or digital magazine before it can open the digital content or use the visual table of contents function. In another example embodiment, the user may read a selected section of the digital content without downloading or purchasing the full magazine or eBook. In such a case, if the users trigger the visual table of contents, it will need to download content on the fly and may draw pages from the cloud. In one such example, if the user does not have the full right to see a specific page, a notification may appear to remind them to purchase the digital content.

Numerous variations and embodiments will be apparent in light of this disclosure. One example embodiment of the present invention provides a device including a touch screen display for displaying digital content to a user and allowing user input. The device also includes a user interface including a user interface including a visual table of contents mode that can be activated in response to an activation command performed while the device is displaying paginated digital content, wherein the visual table of contents mode is configured to display a visual table of contents including a grid of thumbnails each thumbnail associated with a page of the paginated content. In some cases, the thumbnails are displayed in a page spread format, wherein a page spread includes two thumbnails displayed joined together, each associated with oppositely facing pages of the paginated digital content. In some such cases, a page spread includes a virtual binding between oppositely facing thumbnails, the thumbnails being shaded proximal to the center crease. In other such cases, the thumbnails associated with a front cover and back cover of the paginated digital content are displayed in a single page format. In other such cases, in response to the device being held in landscape position, the visual table of contents mode is configured to display a spread of pages in response to the user selecting a corresponding one of the thumbnails. In some cases, the activation command is triggered in response to one of a two-contact inward pinch gesture and/or selection of a visual table of contents touch screen feature. In some cases, the visual table of contents includes a thumbnail associated with the paginated digital content displayed on the device when the activation gesture is performed. In some cases, each thumbnail is accompanied by a corresponding page number. In some cases, the visual table of contents includes more thumbnails than may be displayed on a single screen, and wherein the visual table of contents may display previous or subsequent thumbnails in response to a scrolling command. In some cases, the visual table of contents mode is configured to display a specific page of content in response to the user selecting a thumbnail associated with the specific page.

Another example embodiment of the present invention provides a mobile computing system including a processor and a touch screen display for displaying content to a user and allowing user input, and a user interface executable on the processor and including a visual table of contents mode that can be activated in response to an activation command performed while the device is displaying paginated digital content, wherein the visual table of contents mode is configured to display a visual table of contents including a grid of thumbnails each thumbnail associated with a page of the paginated content. In some cases, the thumbnails are displayed in a page spread format, wherein a page spread includes two thumbnails displayed joined together, each associated with oppositely facing pages of the paginated digital content.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to receive at the electronic device a visual table of contents activation command performed while the device is displaying paginated digital content, and display on the electronic device a visual table of contents including a grid of thumbnails, each thumbnail associated with a page of the paginated digital content. In some cases, the thumbnails are displayed in a page spread format, wherein a page spread includes two thumbnails displayed joined together, each associated with oppositely facing pages of the paginated digital content. In some such cases, a page spread includes a virtual binding between oppositely facing thumbnails, the thumbnails being shaded proximal to the virtual binding. In other such cases, the thumbnails associated with a front cover and back cover of the paginated digital content are displayed in a single page format. In some cases, the process further includes receiving at the electronic device a thumbnail selection command; and displaying on the electronic device a page of the paginated digital content associated with the selected thumbnail. In some cases, the visual table of contents activation command includes at least one of a two-contact inward pinch gesture, and/or selecting a visual table of contents touch screen control feature. In some cases, each thumbnail is accompanied by a corresponding page number. In some cases, the visual table of contents includes more thumbnails than may be displayed on a single screen, and the process further includes displaying on the electronic device previous or subsequent thumbnails in response to a scrolling command

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a touch screen display for displaying content to a user and allowing user input; and
a user interface including a visual table of contents mode that can be activated in response to an activation command performed while the device is displaying paginated digital content, wherein the visual table of contents mode is configured to display a visual table of contents comprising a grid of thumbnails each thumbnail associated with a page of the paginated content.

2. The device of claim 1 wherein the thumbnails are displayed in a page spread format, wherein a page spread includes two thumbnails displayed joined together, each associated with oppositely facing pages of the paginated digital content.

3. The device of claim 2 wherein a page spread includes a virtual binding between oppositely facing thumbnails, the thumbnails being shaded proximal to the center crease.

4. The device of claim 2 wherein the thumbnails associated with a front cover and back cover of the paginated digital content are displayed in a single page format.

5. The device of claim 2 wherein, in response to the device being held in landscape position, the visual table of contents mode is configured to display a spread of pages in response to the user selecting a corresponding one of the thumbnails.

6. The device of claim 1 wherein the activation command is triggered in response to one of a two-contact inward pinch gesture and/or selection of a visual table of contents touch screen feature.

7. The device of claim 1 wherein the visual table of contents includes a thumbnail associated with the paginated digital content displayed on the device when the activation gesture is performed.

8. The device of claim 1 wherein each thumbnail is accompanied by a corresponding page number.

9. The device of claim 1 wherein the visual table of contents includes more thumbnails than may be displayed on a single screen, and wherein the visual table of contents may display previous or subsequent thumbnails in response to a scrolling command.

10. The device of claim 1 wherein the visual table of contents mode is configured to display a specific page of content in response to the user selecting a thumbnail associated with the specific page.

11. A mobile computing system, comprising:
a processor and a touch screen display for displaying content to a user and allowing user input; and
a user interface executable on the processor and including a visual table of contents mode that can be activated in response to an activation command performed while the device is displaying paginated digital content, wherein the visual table of contents mode is configured to display a visual table of contents comprising a grid of thumbnails each thumbnail associated with a page of the paginated content.

12. The system of claim 11 wherein the thumbnails are displayed in a page spread format, wherein a page spread includes two thumbnails displayed joined together, each associated with oppositely facing pages of the paginated digital content.

13. A computer program product comprising a plurality of instructions non-transiently encoded thereon to facilitate operation of an electronic device according to the following process:
receive at the electronic device a visual table of contents activation command performed while the device is displaying paginated digital content; and
display on the electronic device a visual table of contents comprising a grid of thumbnails, each thumbnail associated with a page of the paginated digital content.

14. The computer program product of claim 13 wherein the thumbnails are displayed in a page spread format, wherein a page spread includes two thumbnails displayed joined together, each associated with oppositely facing pages of the paginated digital content.

15. The computer program product of claim 14 wherein a page spread includes a virtual binding between oppositely facing thumbnails, the thumbnails being shaded proximal to the virtual binding.

16. The computer program product of claim 14 wherein the thumbnails associated with a front cover and back cover of the paginated digital content are displayed in a single page format.

17. The computer program product of claim 13 wherein the process further comprises:
receive at the electronic device a thumbnail selection command; and
display on the electronic device a page of the paginated digital content associated with the selected thumbnail.

18. The computer program product of claim 13 wherein the visual table of contents activation command comprises at least one of a two-contact inward pinch gesture, and/or selecting a visual table of contents touch screen control feature.

19. The computer program product of claim 13 wherein each thumbnail is accompanied by a corresponding page number.

20. The computer program product of claim 13 wherein the visual table of contents includes more thumbnails than may be displayed on a single screen, and wherein the process further comprises: display on the electronic device previous or subsequent thumbnails in response to a scrolling command.
